(19) United States
(12) Patent Application Publication
(10) Pub. No.: US 2019/0305594 A1
(43) Pub. Date: Oct. 3, 2019

(54) INFORMATION PROCESSING DEVICE, CONTROL METHOD FOR INFORMATION PROCESSING DEVICE, AND PROGRAM

(71) Applicant: CANON KABUSHIKI KAISHA, Tokyo (JP)

(72) Inventor: Wataru Tachiwa, Yokohama-shi (JP)

(21) Appl. No.: 16/443,737

(22) Filed: Jun. 17, 2019

Related U.S. Application Data
(63) Continuation of application No. PCT/JP2017/044651, filed on Dec. 13, 2017.

(30) Foreign Application Priority Data
Dec. 20, 2016 (JP) 2016-247010

(51) Int. Cl. H02J 50/10; H02J 7/00; H02J 50/80; H02J 50/40; H02J 7/02; H04M 1/725

(52) U.S. Cl. CPC H02J 50/10; H02J 7/0047; H02J 50/80; H04M 2250/02; H02J 7/025; H04M 1/7253; H02J 2007/005; H02J 50/40

(57) ABSTRACT

A power reception device includes power reception unit configured to receive wirelessly power from a power transmission device, and display control unit configured to cause information indicating a battery remaining amount of a different power reception device to be displayed on a display unit of the power reception device in a case where power is received by the power reception unit.

### CROSS-REFERENCE TO RELATED APPLICATIONS

This application is a Continuation of International Patent Application No. PCT/JP2017/044651, filed Dec. 13, 2017, which claims the benefit of Japanese Patent Application No. 2016-247010, filed Dec. 20, 2016, both of which are hereby incorporated by reference herein in their entirety.

### TECHNICAL FIELD

The present invention relates to a wireless power transfer.

### BACKGROUND ART

Wireless power transfer systems including a power transmission device that transmits power wirelessly and a power reception device that receives power supplied from the power transmission device have been known. By wireless power transfer, devices such as smartphones and smartwatches with a battery that can be charged when placed on a charging cradle have become widespread. As standard specifications for wireless power transfer that the above devices support, Qi®, Rezence®, and the like have been known.

For example, if a user forgets to charge a battery and the battery remaining amount becomes zero, a device may stop in the middle of processing. To solve this, Patent Literature 1 discloses a technique in which in the case where the battery remaining amount is expected to become zero in the middle of processing, a user is notified in advance at the start time of the processing that the battery remaining amount is expected to become zero.

### CITATION LIST

### Patent Literature

PTL 1 Japanese Patent Laid-Open No. 2009-4965

However, even in the case where the technique described in PTL 1 is used, if a plurality of devices need to be charged, it may be difficult for a user to understand the charged state of each of the devices. For example, it may be especially difficult to understand the charged state of a wearable device such as a smartwatch.

### Summary of Invention

A power reception device according to the present disclosure includes power reception unit configured to wirelessly receive power from a power transmission device; and display control unit configured to cause information indicating a battery remaining amount of a different power reception device to be displayed on a display unit of the power reception device in a case where power is received by the power reception unit.

Further features of the present disclosure will become apparent from the following description of exemplary embodiments with reference to the attached drawings.

### BRIEF DESCRIPTION OF DRAWINGS

FIG. 1 is a diagram illustrating a configuration of a wireless power transfer system.

FIG. 2 is a diagram illustrating a configuration of a power transmission device.

FIG. 3 is a diagram illustrating a configuration of a power reception device.

FIG. 4 is a diagram illustrating a flowchart of the power reception device.

FIG. 5 is a diagram illustrating a display example of notification to a user.

FIG. 6 is a diagram illustrating an example of a sequence of the wireless power transfer system.

### DESCRIPTION OF EMBODIMENTS

In an embodiment, a technique for notifying information regarding the charged state of a different device will be explained.

Hereinafter, an embodiment will be explained with reference to drawings. A configuration described in the embodiment described below is merely an example, and the present invention is not intended to be limited to the illustrated configuration.

### <System Configuration>

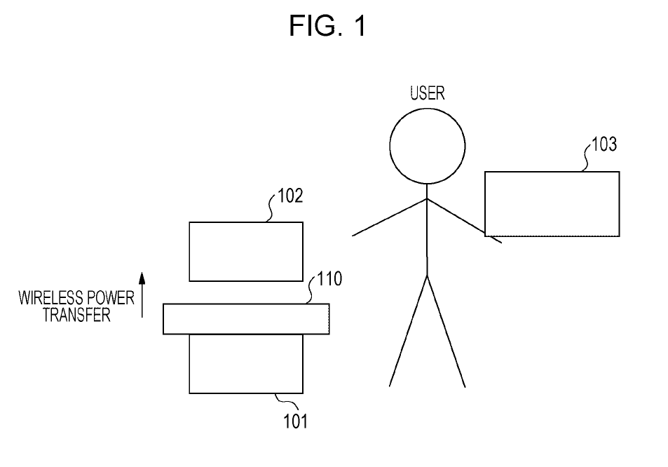

A configuration of a wireless power transfer system that performs wireless power transfer according to an embodiment is illustrated in FIG. 1. The wireless power transfer system according to this embodiment performs wireless power transfer using a magnetic field resonance method. The magnetic field resonance method is a method for transferring power by coupling caused by resonance of a magnetic field (resonance) between a resonator (resonance element) of a power transmission device and a resonator (resonance element) of a power reception device. However, the wireless power transfer method (contactless power transfer method) is not limited to the magnetic field resonance method. An electromagnetic induction method, an electric field resonance method, a microwave method, or a power transfer method using a laser or the like may be used. Furthermore, a wireless power transfer system that performs wireless power transfer according to an embodiment may be based on Qi standards or another method compatible with the Qi standards.

In FIG. 1, 101 denotes a power transmission device and 102 and 103 denote power reception devices (information processing devices). The power transmission device 101 is a power transmission device that transmits power wirelessly to an object placed on a charging cradle 110. The power reception device 102 and the power reception device 103 are power reception devices that receive power transmitted wirelessly from the power transmission device 101. Each of the power reception device 102 and the power reception device 103 includes a battery that can be used as a power source for the device, and the battery is charged by power received from the power transmission device 101. The power reception device 102 is, for example, a smartphone. The power reception device 103 is, for example, a smartwatch. The power reception device 102 and the power reception device 103 are not limited to the examples mentioned above and may be difference types of devices.

The power transmission device 101 transmits power for charging in the case where the power transmission device 101 authenticates an object placed on the charging cradle 110 by communication and the object is a power reception device. Furthermore, the power transmission device 101 performs control for stopping transmission of power or the like when the power reception device is fully charged. The power transmission device 101 is not necessarily a device dedicated to power transmission. The power transmission device 101 may be a device such as a printer, a personal computer, or the like.

In the wireless power transfer system according to this embodiment, the power transmission device 101 communicates wirelessly with a power reception device that is placed on the charging cradle 110. Furthermore, apart from this, the power reception device 102 and the power reception device 103 communicate wirelessly with each other.

First, wireless communication between the power transmission device 101 and a power reception device placed on the charging cradle 110 will be described. Between the power transmission device 101 and the power reception device, control information for controlling communication to be used for authentication and wireless power transfer is communicated. Hereinafter, transmission and reception of power between devices will be represented by power transmission, power reception, or power transfer (wireless power transfer), and exchange for authentication and exchange of control information between devices will be simply represented by communication (wireless communication).

As communication performed between a power transmission device and a power reception device in a wireless power transfer system according to this embodiment, communication conforming to Bluetooth® 4.0 standards is used. In Bluetooth® 4.0, a communication method that is capable of communication with a relatively low power consumption such as Bluetooth® Low Energy (BLE) is defined. In the wireless power transfer system, the power transmission device 101 operates as a central defined by BLE, which is a base station of a network. To transmit power to a plurality of power reception devices at once, the power transmission device 101 needs to communicate with each of the plurality of power reception devices. Thus, to communicate with each of the plurality of power reception devices, the power transmission device 101 operates as a central. Furthermore, a power reception device operates as a peripheral defined by BLE, which is connected to the central and performs communication under the control of the central. The power transmission device 101 may be a peripheral and the power reception device 102 may be a central.

Communication in this embodiment has been explained as communication performed in conformity with BLE. However, the communication in this embodiment may be based on a different type of communication standards. For example, the communication in this embodiment may be, for example, a wireless LAN (IEEE (The Institute of Electrical and Electronics Engineers, Inc.) 802.11 series). Furthermore, the communication in this embodiment may be NFC (Near Field Communication), ZigBee®, or the like. Furthermore, an upgraded communication method such as Bluetooth® 5.0 standards may be used. Furthermore, the communication may be based on a unique communication method or load modulation. In this example, a single power transmission device is illustrated. However, two or more power transmission devices may be provided.

### <Configuration of Power Transmission Device>

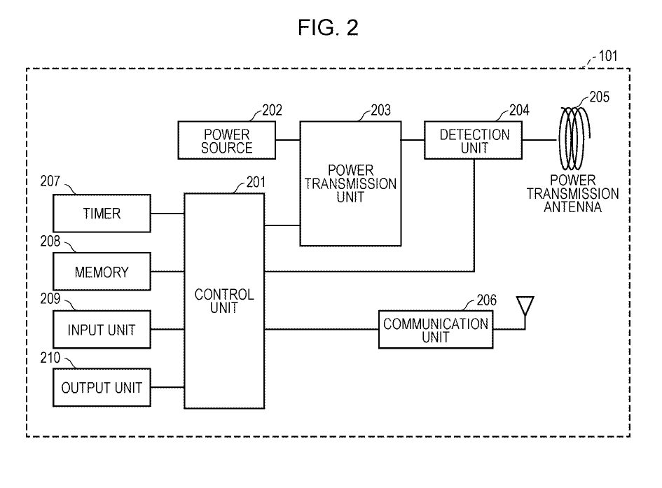

Next, a configuration of each device of the wireless power transfer system will be explained. FIG. 2 is a diagram illustrating a configuration of the power transmission device 101 of the wireless power transfer system. The power transmission device 101 includes a control unit 201, a power source 202, a power transmission unit 203, a detection unit 204, a power transmission antenna 205, a communication unit 206, a timer 207, a memory 208, an input unit 209, and an output unit 210.

The control unit 201 controls an operation of the entire device by reading and executing a control program stored in the memory 208. For example, the control unit 201 is a CPU (Central Processing Unit). The control unit 201 also uses the memory 208 for storing a variable value while the control program being executed. Furthermore, the control unit 201 uses the timer 207 for measuring time.

The power source 202 supplies power for wireless power transfer from the power transmission device 101. The power source 202 is a commercial power source or a battery. The power transmission unit 203 converts DC or AC power input from the power source 202 into AC frequency power of a frequency band to be used for transfer and generates electromagnetic waves for allowing a power reception device to receive power via the power transmission antenna 205. The power transmission unit 203 causes electromagnetic waves for power transmission to the power reception device to be output from the power transmission antenna 205, based on an instruction from the control unit 201. Furthermore, the power transmission unit 203 adjusts voltage (power transmission voltage) to be input to the power transmission antenna 205 to control the intensity of electromagnetic waves to be output. As the power transmission voltage increases, the intensity of electromagnetic waves increases. Furthermore, the power transmission unit 203 performs control to stop power transmission from the power transmission antenna 205, based on an instruction from the control unit 201.

The detection unit 204 detects power transmission voltage and the size of current (power transmission current) at the power transmission antenna 205. The power transmission voltage and power transmission current detected by the detection unit 204 are read by the control unit 201. In the case where the correlation between the power transmission voltage and power transmission current and the voltage and current input from the power source 202 to the power transmission unit 203 is already known, the detection unit 204 may be configured to detect the voltage and current input to the power transmission unit 203. At this time, the power transmission voltage and the power transmission current may be obtained by a calculation based on the known correlation by the control unit 201, based on a detection value obtained from the detection unit 204.

The communication unit 206 communicates with a power reception device. The communication unit 206 includes a chip for controlling wireless communication conforming to BLE and an antenna for transmitting and receiving signals. The input unit 209 receives various operations from a user. The output unit 210 performs various types of outputting to the user. Here, outputting by the output unit 210 includes at least one of displaying onto a screen, outputting sound from a speaker, outputting vibrations, and the like.

### <Configuration of Power Reception Device>

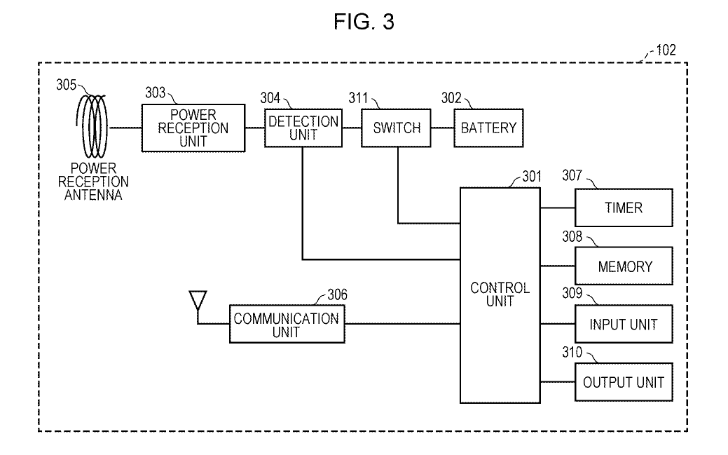

Next, a configuration of the power reception device 102 of the wireless power transfer system will be explained with reference to FIG. 3. The power reception device 102 includes a control unit 301, a battery 302, a power reception unit 303, a detection unit 304, a power reception antenna 305, a communication unit 306, a timer 307, a memory 308, an input unit 309, an output unit 310, and a switch 311. The control unit 301 is a control unit that controls the power reception device 102. The control unit 301 is a CPU that controls the entire device using the timer 307, the memory 308, the input unit 309, and the output unit 310, as with the control unit 201.

The communication unit 306 includes a chip for controlling wireless communication conforming to BLE and an antenna for transmitting and receiving signals. The power reception antenna 305 receives electromagnetic waves for transferring power supplied wirelessly from the power transmission device 101. The power reception unit 303 is a power reception unit that generates power from electromagnetic waves received by the power reception antenna 305. The power reception unit 303 generates resonance based on electromagnetic waves received by the power reception antenna 305 and obtains AC power from the resonance. Then, the power reception unit 303 converts the AC power into DC or AC power at a desired frequency and outputs the converted DC or AC power. The battery 302 stores power. Based on the size of the output voltage of the battery 302, the control unit 301 detects whether or not the battery 302 is fully charged or detects the amount of stored power and the remaining amount.

The control unit 301 controls the switch 311 to control whether or not power is to be output to the battery 302. When the switch 311 is ON, power is output to the battery 302. When the switch 311 is OFF, power is not output to the battery 302 but is output to the power reception unit 303, the control unit 301, and the communication unit 306. The default state of the switch 311 is OFF.

The detection unit 304 is a detection unit that detects electromotive force (power reception voltage) generated at the power reception antenna 305, based on electromagnetic waves transmitted from the power transmission antenna 205 of the power transmission device 101. The power reception voltage detected by the detection unit 304 may be referred to by the control unit 301. As in the explanation for the detection unit 204, the detection unit 304 may be configured to detect voltage output from the power reception unit 303.

The power reception unit 303, the control unit 301, and the communication unit 306 of the power reception device 102 operate using power supplied from the battery 302, during a period in which power is not received. The power reception unit 303, the control unit 301, and the communication unit 306 of the power reception device 102 may be configured to operate using power transmitted from the power transmission device 101, during a period in which power is received.

The input unit 309 and the output unit 310 receive various operations from a user and perform various types of outputting to the user, as with the input unit 209 and the output unit 210 of the power transmission device 101. Both the input unit 309 and the output unit 310 may be implemented by a single module, as with a touch panel.

### <Types of Power Transmission>

The power transmission device 101 in the wireless power transfer system having the configuration described above selectively performs one of power transmission for power transmission for detection for authentication, and power transmission for charging.

The power transmission for detection is a type of power transmission for detecting whether or not at least one object is placed on the power transmission device 101. In the power transmission for detection, the power transmission device 101 intermittently generates weak electromagnetic waves from the power transmission antenna 205. Accordingly, power consumption during a period in which no object is placed can be reduced. In the case where an object is placed in a power transmission range of the power transmission device 101, that is, on the charging cradle 110, while power transmission for detection is being performed, the power transmission for detection is consumed by the object. In this case, the impedance of the power transmission antenna 205 of the power transmission device 101 changes, and current different from a steady state, that is, a state in which no power receiving object is placed, flows to the power transmission antenna 205. The detection unit 204 detects the change, and the power transmission device 101 is thus able to detect that the object is placed in the power transmission range of the power transmission device 101.

The power transmission device 101 stores in advance a change value of a detection result of the detection unit 204 for the case where the power reception device 102 is present in the power transmission range. In the case where the detection result of the detection unit 204 represents a change amount that exceeds the change value stored in advance relative to the detection result in the steady state, the power transmission device 101 detects that an object is placed in the power transmission range.

Furthermore, power transmission for authentication is a type of power transmission for supplying power required for a power reception device present in a power transmission range to perform communication for authentication, that is, power sufficient for the control unit 301 and the communication unit 306 of the power reception device to be activated, even in the case where there is no battery remaining amount. When detecting that an object is present in the power transmission range of the power transmission device 101, the power transmission device 101 starts power transmission for authentication. It may be configured such that, in the case where there is a sufficient battery remaining amount to activate the control unit 301 and the communication unit 306 of the power reception device, the power reception device does not use power received through power transmission for authentication.

Within a certain period of time (for example, 100 milliseconds) from detection of power transmission for authentication, the power reception device 102 that receives the power transmission for authentication transmits, from the communication unit 306, an advertising packet for allowing a different device to transmit a communication connection request. In the case where the power transmission device 101 receives the advertising packet from the power reception device 102 that is in response to the power transmission for authentication, the power transmission device 101 determines that the power reception device 102 is present in the power transmission possible range.

An advertising packet is a signal defined by BLE transmitted by broadcasting. An advertising packet is a notification signal, which is transmitted from a device, for notifying an adjacent device supporting BLE that the device is present. The advertising packet includes information such as the name of the device and the type of a service to be supplied by the device. Furthermore, the advertising packet is used to notify a neighboring device that the device is present and the device is waiting for connection from the neighboring device. The advertising packet from the power reception device 102 includes service information indicating that the power reception device 102 is a power reception device for wireless power transfer. In the explanation provided below, an advertising packet will be referred to as presence notification.

In the case where the power transmission device 101 does not receive present notification from the power reception device 102 within a predetermined period of time (for example, 100 milliseconds) from the start of power transmission for authentication, the power transmission device 101 stops power transmission for authentication. Then, the power transmission device 101 performs power transmission for detection in an intermittent manner by causing electromagnetic waves to be intermittently generated again by the power transmission antenna 205.

Furthermore, the power transmission device 101 transmits, via the communication unit 206, a Connection Request packet (connection request) to the power reception device 102, which is a transmission source of the received presence notification. Then, the power transmission device 101 establishes communication connection with the power reception device 102, in accordance with the transmitted connection request. Then, with the use of the established wireless connection, authenticating processing for negotiation for power transmission is performed between the devices. In the authenticating processing, during the period of the communication connection established between the power transmission device 101 and the power reception device 102, information regarding types of wireless power transfer methods supported by the power transmission device 101 and the power reception device 102 is exchanged. Specifically, such information includes identifiers representing types such as Qi® and Rezence®. Furthermore, such information may include information such as an amount of power that can be transmitted and received, a hardware configuration, a supported version of power transmission standards, and a version of a communication protocol. Furthermore, the power reception device 102 may transmit part of or the entire information as an advertising packet.

In BLE, opportunities for exchange of data packets periodically occur. Such opportunities are referred to as Connection Events. The power transmission device 101 requires, using a data packet transmitted in the first Connection Event, the power reception device 102 to notify the power transmission device 101 of a necessary power value. In response to the request, the power reception device 102 transmits the next data packet including the necessary power value.

The authenticating processing is successful when the types of wireless power transfer methods supported by the power transmission device 101 and the power reception device 102 are the same. As conditions for having the same types, a state in which protocol versions are the same, a state in which the amount of power required by the power reception device 102 is equal to or less than the amount of power that can be transmitted by the power transmission device 101, and the like, as well as a state in which identifiers are the same, may be added. Furthermore, a condition that passwords are exchanged and become the same may be added. Furthermore, a timeout period may be provided for communication for authenticating processing. In the case where authenticating processing does not end within the period, it may be determined that the authenticating processing is unsuccessful. In the case where authentication is unsuccessful, power transmission for charging is not performed.

By the authenticating processing, the power transmission device 101 is able to confirm that an object present in the power transmission range is a power reception device that requires power transmission. In contrast, by the authenticating processing, the power reception device 102 is able to confirm whether or not the power transmission device 101 to which the power reception device 102 is communication-connected is able to supply power. During the authenticating processing, the power transmission device 101 continuously performs power transmission for authentication, so that power transmission for allowing the power reception device 102 to perform communication of capacity information is performed for the power reception device 102.

In the case where authentication by authenticating processing is successful, that is, in the case where negotiation with the power reception device 102 is established, the power transmission device 101 performs power transmission for charging. In the power transmission for charging, an amount of power more than that in power transmission for detection and that in power transmission for authentication is transmitted to the power reception device 102. In execution of power transmission for charging, the power transmission device 101 receives, via the communication unit 206, control information for controlling wireless power transfer, such as the value of power being received, a request for increasing or decreasing the amount of power transmission, and stoppage of power transmission, from the power reception device 102. That is, power transmission for charging is in response to a request from the power reception device 102.

The power transmission device 101 ends power transmission for charging in the case where the power transmission device 101 receives a power transmission stop request for requesting stoppage of power transmission from the power reception device 102 or in the case where an error of power transmission occurs. Furthermore, control information from the power reception device 102 may include error information. For example, in the case where the power transmission device 101 receives from the power reception device 102 control information indicating that an error has occurred, the power transmission device 101 may stop power transmission. Furthermore, in the case where the power transmission device 101 receives a full charge notification indicating that the power reception device 102 is fully charged, the power transmission device 101 stops power transmission for charging to the power reception device 102 from which the full charge notification is transmitted. Furthermore, in the case where the power transmission device 101 receives a power transmission stop request from the power reception device 102 while transmitting power to a plurality of power reception devices, the power transmission device 101 stops power transmission for charging to the power reception device 102 from which the power transmission stop request is transmitted and continues to perform power transmission to the other power reception devices.

Furthermore, when authenticating processing is successful, the power reception device 102 causes the control unit 301 to change the switch 311 from OFF to ON to store power supplied by the power transmission for charging. That is, the power reception device 102 performs control such that power is not supplied to the battery 302 until power transmission for charging starts. Furthermore, to end charging, the power reception device 102 causes the control unit 301 to change the switch 311 from ON to OFF.

Furthermore, the power transmission device 101 is able to transmit power to a plurality of power reception devices. For example, in the case where the power transmission device 101 is performing power transmission for charging to a first power reception device, a second power reception device that newly requires power reception transmits a presence notification to the power transmission device 101 in the case where power transmission for charging to the first power reception device is detected. When receiving the presence notification, the power transmission device 101 starts authenticating processing for the second power reception device. In the case where authentication is successful, the power transmission device 101 starts power transmission for charging to the second power reception device. As described above, the power transmission device 101 is able to perform power transmission for charging for a plurality of power reception devices at the same time.

As described above, in the case where the power reception device 102 is placed on the charging cradle 110, the power reception device 102 is able to receive power from the power transmission device 101 so that the battery 302 can be charged. The power reception device 103 has a configuration similar to that of the power reception device 102. In the case where the power reception device 103 is placed on the charging cradle 110, the power reception device 103 is able to receive power from the power transmission device 101. Furthermore, in the case where both the power reception devices 102 and 103 are placed on the charging cradle 110, the power reception devices 102 and 103 may receive power from the power transmission device 101 at the same time.

<Communication between Power Reception Devices>

Next, communication between the power reception device 102 and the power reception device 103 will be described. Explanation will be provided on the assumption that communication between the power reception device 102 and the power reception device 103 is also performed based on BLE. Two types of communications, communication for application and communication regarding wireless power transfer, are performed. In BLE, the two types of communications are implemented as different services, and are therefore able to be performed concurrently. BLE communication with the power transmission device 101 and BLE communication with a power reception device can be performed concurrently in a similar manner. Other wireless communication methods such as wireless LAN and ZigBee® may be used.

Application communication represents communication for implementing general application that allows, in the case where the power reception device 102 and the power reception device 103 are a smartphone and a smartwatch, respectively, an electronic mail received at the smartphone to be displayed on the smartwatch. Such application can be implemented easily with a related art. Therefore, explanation for such application will be omitted. Display of an electronic mail is an example, and communication for different application may be performed.

Communication regarding wireless power transfer represents communication in which the power reception device 102 acquires the type of a wireless power transfer method supported by the power reception device 103 and the charged state of the battery 302 of the power reception device 103.

To perform the two types of communications, the power reception device 102 and the power reception device 103 use the control unit 301 and the communication unit 306. The communication unit 306 may be used as a unit dedicated to communication with the power transmission device 101, and a different communication unit may be used for communication between power reception devices.

### <Process>

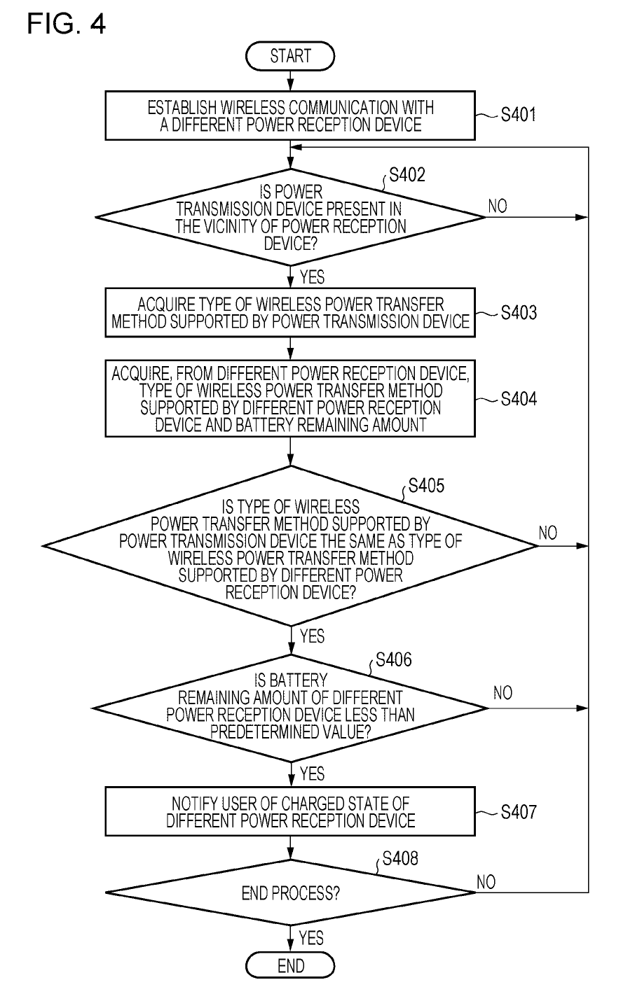

FIG. 4 is a flowchart illustrating a procedure of a process performed by the control unit 301 of the power reception device 102 according to this embodiment. First, the power reception device 102 establishes, using the communication unit 306, wireless communication with the different power reception device 103 (S401). This processing is performed by receiving an advertising packet from the different power reception device 103 and issuing a connection request. Next, the power reception device 102 determines whether or not the power transmission device 101 is present in the vicinity of the power reception device 102 (S402). This determination processing is performed based on whether or not the detection unit 304 has detected power transmission from the power transmission device 101 or whether or not the detection unit 304 has detected a connection request from the power transmission device 101. In the case where the power transmission device 101 is present, the power reception device 102 acquires information indicating the type of a wireless power transfer method supported by the power transmission device 101 (S403: first acquisition processing). This is performed in the authenticating processing for a power reception device performed by the power transmission device 101 described above.

Then, the power reception device 102 acquires, from the different power reception device 103 with which wireless communication has already been established, information indicating the type of a wireless power transfer method supported by the different power reception device 103 and information indicating the battery remaining amount, that is, the charged state (S404: second acquisition processing). Here, the power reception device 102 determines whether or not the type of the wireless power transfer method supported by the power transmission device 101 and the type of the wireless power transfer method supported by the different power reception device 103 are the same (S405). In the case where the types are the same, it is determined that the different power reception device 103 is able to be charged using the power transmission device 101. At this time, if the battery remaining amount of the different power reception device is less than a predetermined value (S406), the power reception device 102 performs control such that the charged state of the different power reception device 103 is notified, using the output unit 310, to a user (S407).

After that, it is determined whether or not to end the process (S408). For example, in the case where the power source of the power reception device 102 is turned OFF, the process ends. In the case where the power source of the power reception device 102 is not turned OFF, the process returns to S402 to continue the process. In contrast, in the case where the types of the wireless power transfer methods are not the same (NO in S405) or in the case where the battery remaining amount of the different power reception device 103 is equal to or more than the predetermined value (NO in S406), the process returns to S402 without notifying the charged state.

### <Example of Charged State>

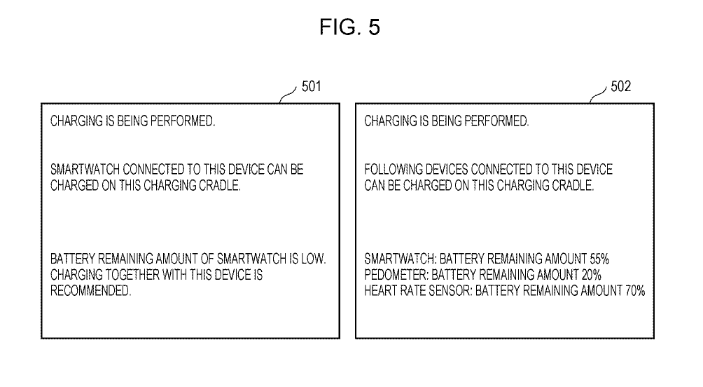

FIG. 5 illustrates an example of the charged state of the different power reception device 103 that sends a notification to the user in S407 of FIG. 4. Display 501 represents an example of display notified to a user in the case where the power reception device 103 is a smartwatch. For notification of the charged state of the different power reception device 103 as in the display 501, an identifier or a name for allowing the user to identify the different power reception device 103 may be provided. Furthermore, a sentence prompting the user to charge the different power reception device 103 may be added. Furthermore, the notification of the charged state in S407 may be notification of information, which is to be sent to the power transmission device 101, indicating that charging of the different power reception device 103 may be performed by wireless power transfer. Furthermore, the notification of the charged state in S407 may be notification of information, which is to be sent to the power transmission device 101, for prompting the user to charge the different power reception device 103 by wireless power transfer.

Furthermore, in the case where there are a plurality of different power reception devices, wireless communication with each of the plurality of different power reception devices may be established in S401, and information may be acquired from each of the plurality of different power reception devices in S403 and S404. In this case, a list of different power reception devices that support the same type of wireless power transfer method as that supported by the power transmission device in S405 may be notified to the user as in display 502, regardless of the battery remaining amount. In this case, the processing of S406 may be omitted. The above examples are merely examples. Other types of display may be provided as long as information regarding the charged state of a different power reception devices is provided.

### <Operation Example of Each Device Configuring Wireless Power Transfer System>

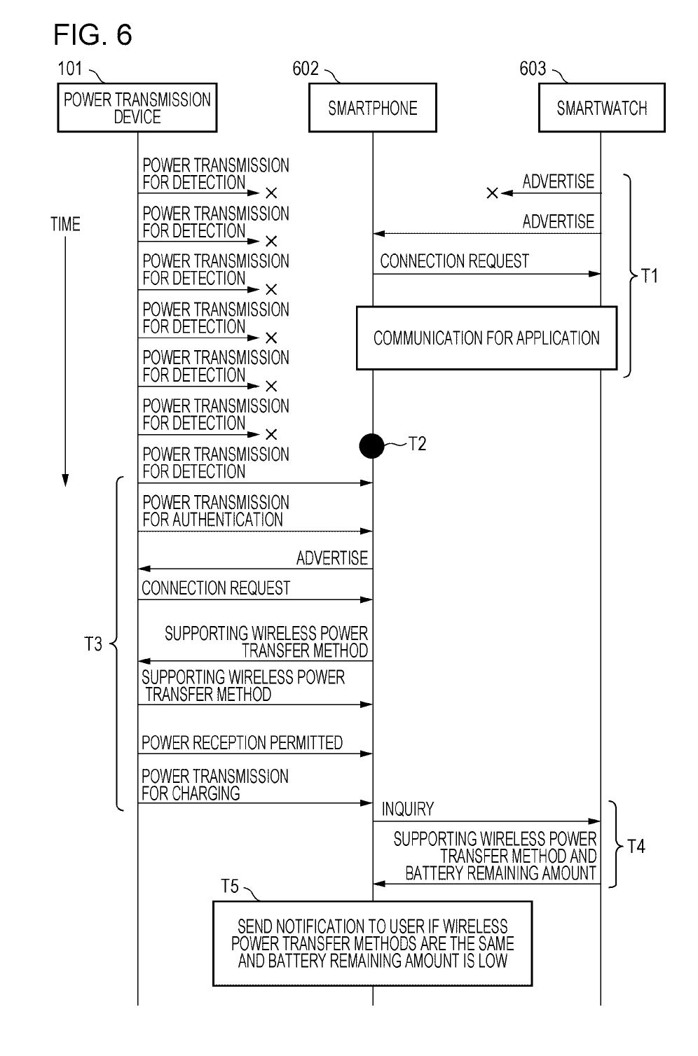

Next, an operation example of each device configuring the wireless power transfer system according to this embodiment will be explained with reference to FIG. 6. In FIG. 6, time flows from the top to bottom of the figure. In FIG. 6, the power transmission device 101 is a power transmission device that supports wireless power transfer by Rezence®. Furthermore, a smartphone 602 and a smartwatch 603 are power reception devices that support wireless power transfer by Rezence® and have a configuration similar to that of the power reception device 102 in FIG. 2. Furthermore, at least the control unit 301 of the smartphone 602 has a function for executing the flowchart of FIG. 4.

First, at time T1, the smartphone 602 performs the processing of S401 in which wireless communication with the smartwatch 603 is established and conventional communication for application is performed. After that, at time T2, a user who carries both the smartphone 602 and the smartwatch 603 reaches near the power transmission device 101 and places the smartphone 602 on a charging cradle.

Then, at time T3, authenticating processing for power transmission is performed between the power transmission device 101 and the smartphone 602. In the course of processing, the smartphone 602 detects that the power transmission device 101 is present in the vicinity of the smartphone 602. Therefore, a determination result in S402 is YES. Moreover, in the course of authenticating processing, S403 is performed, and the fact that the power transmission device 101 supports Rezence® is also detected. Next, at time T4, the smartphone 602 performs the processing of S404 in which, by the wireless communication that has already been established at the time T1, information indicating that the smartwatch 603 supports Rezence® and information indicating that the battery remaining amount is low are acquired.

Here, the smartphone 602 has acquired the information indicating that both the power transmission device 101 present in the vicinity of the smartphone 602 and the smartwatch 603 support Rezence®. Therefore, the determination result in S405 is YES. Then, based on the information, which has already been acquired, indicating that the battery remaining amount of the smartwatch 603 is low, the determination result in S406 is YES, and the display 501 is provided in S407. That is, when the smartphone 602 is placed on the charging cradle of the power transmission device 101, the charged state of the smartwatch 603, which is also able to be charged by the power transmission device 101, is notified to a user.

Accordingly, the user can be prevented from forgetting to allow the smartwatch 603 to be charged, and the convenience of the device can be increased. Obviously, similar effects can be achieved even in a case where a power reception device is a device different from a smartphone or a smartwatch, such as, for example, a camera.

In this embodiment, wireless communication with a different power reception device is established in advance in S401 of FIG. 4. However, this processing may be performed after the determination result YES is obtained in S402 or after the processing of S403. In this case, after the smartphone 602 is placed on a charging cradle for the power transmission device 101, the smartphone 602 establishes wireless communication with the smartwatch 603. Accordingly, even during a period in which no application is used between the smartphone 602 and the smartwatch 603, the charged state of the smartwatch 603 may be notified to the user at the timing when the smartphone 602 is placed on the charging cradle.

Furthermore, in S402 of FIG. 4, it may be determined, by a method different from a method for detecting power transmission for detection from the power transmission device 101, that the power transmission device 101 is present in the vicinity of the power reception device. For example, presence notification may be transmitted by causing the power transmission device 101 to intermittently transmit an advertising packet.

The power reception device 102 receives an advertising packet transmitted from the power transmission device 101, and is therefore able to detect that the power transmission device 101 is present in the vicinity of the power reception device 102. Furthermore, in the case where the power reception device 102 includes a GPS (Global Positioning System), the position (location) of the power transmission device 101 is stored in advance in the memory 308. Then, in the case where the distance between the current location of the power reception device 102 detected by the GPS and the position (location) of the power transmission device 101 is less than or equal to a predetermined value, it may be determined that the power transmission device 101 is present in the vicinity of the power reception device 102. With the method described above, the power reception device 102 is able to detect that even a power transmission device that does not perform power transmission for detection is present in the vicinity of the power reception device 102.

The smartphone 602 (power reception device 102) may acquire information indicating the charged state of the smartwatch 603 from the smartwatch 603 or from the power transmission device 101 or a different device such as a server.

Furthermore, the smartphone 602 may be configured to display information indicating the charged state of only a different power reception device that has logged in the same account as the smartphone 602. Here, an account may be logged in using identification information such as an e-mail address and a password. Furthermore, an account may be used for services such as downloading application, buying content such as music or movies, and storing data.

Furthermore, in the case where, after time T5 (notification in S407) in FIG. 6, the smartwatch 603 is placed on the power transmission device 101 and charging of the smartwatch 603 is started, the smartphone 602 may display information indicating that charging of the smartwatch 603 is being performed and the battery remaining amount of the smartwatch 603. In this case, when charging is stopped because the smartphone 602 or the smartwatch 603 has moved outside the power transmission range of the power transmission device 101 or the like, the smartphone 602 may stop notification of the charged state of the smartwatch 603. Furthermore, in the case where the smartwatch 603 performs charging and the battery remaining amount reaches a threshold value (for example, 80%) or more, the smartphone 602 may display information indicating that the battery of the smartwatch 603 has been fully charged. Furthermore, in the case where communication connection with the smartwatch 603 is disconnected, the smartphone 602 may stop notification of the charged state of the smartwatch 603.

As described above, according to this embodiment, the charged state of a wearable device such as a smartwatch including a relatively small display unit for which charging is started may be displayed on a smartphone including a relatively large display unit. Therefore, the visibility of the charged state of a plurality of devices that are charged may be increased, and a user is able to understand the charged state of each of the devices.

Furthermore, in this embodiment, when a user places a device on a charging cradle, information of a device that is able to be charged on the same charging cradle, out of devices carried by the user, can be notified. Therefore, in the case where a plurality of devices need to be charged, a situation in which the user forgets to charge each device can be prevented, and the convenience for the user can be increased.

### OTHER EMBODIMENTS

The present disclosure can also be implemented by processing for supplying a program that implements one or more functions of the foregoing embodiment to a system or a device via a network or a storing medium and reading and executing, with one or more processors in a computer of the system or the device, the program. Furthermore, the present disclosure can also be implemented by a circuit (for example, an ASIC) that implements one or more functions.

The present invention is not limited to the foregoing embodiment, and various changes and modifications can be made to the present invention without departing from the spirit and scope of the present invention. Therefore, to apprise the public of the scope of the present invention, the following claims are made.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A power reception device comprising:
power reception unit configured to wirelessly receive power from a power transmission device; and
display control unit configured to control a display unit of the power reception device,
wherein in a case where power is wirelessly received by the power reception device, together with a different power reception device, from the power transmission device, the display control unit is able to cause information indicating a battery remaining amount of the different power reception device that is wirelessly receiving power from the power transmission device to be displayed on the display unit.

2. The power reception device according to claim 1, wherein the display control unit causes information indicating the battery remaining amount of the different power reception device in a form of percentage to be displayed, as the information indicating the battery remaining amount of the different power reception device.

3. The power reception device according to claim 1, wherein the display control unit causes the information indicating the battery remaining amount of the different power reception device and identification information of the different power reception device to be displayed in association with each other.

4. The power reception device according to claim 1, wherein the display control unit causes the information indicating the battery remaining amount of the different power reception device and information indicating a type of the different power reception device to be displayed in association with each other.

5. The power reception device according to claim 4, wherein the information indicating the type of the different power reception device is information indicating that the different power reception device is a watch, a pedometer, or a heart rate sensor.

6. The power reception device according to claim 1, further comprising:
acquisition unit configured to acquire the battery remaining amount of the different power reception device by wireless communication,
wherein the display control unit causes the information indicating the battery remaining amount of the different power reception device to be displayed, based on the battery remaining amount of the different power reception device acquired by the acquisition unit.

7. The power reception device according to claim 1, wherein the acquisition unit acquires the battery remaining amount of the different power reception device by communication conforming to Bluetooth standards.

8. The power reception device according to claim 1, wherein the acquisition unit acquires the battery remaining amount of the different power reception device by communication conforming to Bluetooth Low Energy standards.

9. The power reception device according to claim 1, wherein the display control unit causes the information indicating the battery remaining amount of the different power reception device that is able to receive power transmitted from the power transmission device to be displayed.

10. The power reception device according to claim 1, wherein in a case where a plurality of different power reception devices wirelessly receive power from the power transmission device, the display control unit causes information indicating a battery remaining amount of each of a plurality of different power reception devices to be displayed.

11. The power reception device according to claim 1, wherein the display control unit causes information indicating that the power reception device is being charged and information indicating the battery remaining amount of the different power reception device to be displayed.

12. The power reception device according to claim 1, wherein the power reception device is a smartphone.

13. The power reception device according to claim 1, wherein the different power reception device is a smartwatch.

14. The power reception device according to claim 1, wherein the display control unit causes the information indicating the battery remaining amount of the different power reception device to be displayed in a case where the battery remaining amount of the different power reception device is less than a predetermined value.

15. The power reception device according to claim 14, wherein in a case where the battery remaining amount of the different power reception device is equal to or more than the predetermined value, the display control unit causes the information indicating the battery remaining amount of the different power reception device not to be displayed on the display unit.

16. The power reception device according to claim 1, wherein in a case where a wireless power transfer method supported by the power transmission device and a wireless power transfer method supported by the different power reception device are not the same, the display control unit causes the information indicating the battery remaining amount of the different power reception device not to be displayed on the display unit.

17. The power reception device according to claim 1, wherein when power reception by the power reception unit ends, when communication connection between the power reception device and the different power reception device is disconnected, or when power reception by the different power reception device ends, the display control unit ends displaying of the information indicating the battery remaining amount of the different power reception device.

18. The power reception device according to claim 1, further comprising:
login unit configured to log into an account, based on an e-mail address and a password,
wherein the display control unit causes the information indicating the battery remaining amount of the different power reception device that has logged in the same account as that logged in by the login unit to be displayed.

19. A display control method performed by a power reception device, comprising:
wirelessly receiving power from a power transmission device; and
causing information indicating a battery remaining amount of a different power reception device that is wirelessly receiving power from the power transmission device to be displayed on a display unit of the power reception device in a case where power is wirelessly received, together with the different power reception device, from the power transmission device.

20. A non-transitory computer-readable storage medium storing computer executable instructions for causing a computer to execute a display control method performed by a power reception device, the method comprising:
wirelessly receiving power from a power transmission device; and
causing information indicating a battery remaining amount of a different power reception device that is wirelessly receiving power from the power transmission device to be displayed on a display unit of the power reception device in a case where power is wirelessly received, together with the different power reception device, from the power transmission device.
